(19) United States
(12) Patent Application Publication
(10) Pub. No.: US 2011/0076363 A1
(43) Pub. Date: Mar. 31, 2011

(54) CO-EXTRUDED DUAL TEXTURE FOOD PRODUCT

(75) Inventor: Robert L. Niehues, Parkville, MO (US)

(73) Assignee: CROSSWIND INDUSTRIES, INC., Kansas City, MO (US)

(21) Appl. No.: 12/570,721

(22) Filed: Sep. 30, 2009

(51) Int. Cl. A23K 1/00; A23L 1/00; A23P 1/12

(52) U.S. Cl. 426/89

(57) ABSTRACT

A co-extruded dual texture animal or human food product with open ends, a harder outer shell component, and a softer inner filling component is disclosed. The inner softer filling component has viscosity characteristics which allow pumping during the manufacturing process yet without leakage from the cut ends of the product during cutting, drying, or storage. The harder outer shell component is at least 75 times harder than the softer inner filling component which has hardness less than about 0.5 kg force. In certain embodiments, the product could be used as a means of delivering medicants to pets where the medicant is held in place and disguised from the pet by the softer inner component, thus inducing the pet to unknowingly ingest the medicant.

### BACKGROUND OF THE INVENTION

The present disclosure is broadly concerned with a co-extruded dual texture animal or human food product. Dual texture products typically have a harder outer shell portion which is harder than a softer inner filling portion. Such products have application in both human foods and animal foods such as dog or cat foods or foods for other companion animals. In the case of pet foods, they can be formulated as either a treat product or as a food designed to provide complete nutrition. The dual texture nature of these products provides several advantages over single-texture products. These advantages include consumer preference, increased product variety and interest and enhanced palatability and preference. In addition, when properly made, a co-extruded dual texture pet treat may be used as a means of drug delivery by selecting the size and shape of the shell and filling to accept a drug delivery form such as a pill or capsule with the drug delivery form being held in place by the soft inner filling.

### DESCRIPTION OF THE RELATED ART

There are a number of examples of dual-texture pet treats existing in the prior art. U.S. Pat. No. 4,954,061 to Repholz et. al., which is incorporated herein by reference, discloses a dual-texture pet food product having a hard outer shell and a soft inner shell. The '061 patent describes dual texture products as products where the hardness of the hard outer component is about 3.0 to about 30.0 kilograms while the hardness of the inner soft component is 0.5 to about 3.0 kilograms with the hardness being instrumentally measured by determining the force required to advance the conical end of a one-eighth inch diameter pin into the respective components of the dual texture product at a velocity of 0.3 mm/sec. The maximum texture differential between the hard and soft components as disclosed in the '061 patent is limited to about 60:1 obtained by dividing the maximum hardness described for the hard component of 30.0 kilograms by the minimum hardness described for the soft component of 0.5 kilograms.

This described textural difference between the hard and soft components is typical of open-ended products in the present art, open-ended products generally described as products where the shell does not completely surround the filling. If textural differences greater than this are desired, the present art typically uses closed-end or pillow type products as described in U.S. Pat. No. 6,312,746 B2 to Paluch, which is incorporated herein by reference, which discloses a pillow-type dual texture product wherein the soft inner component is completely surrounded by the harder outer component. To those skilled in the art, it is understood that the purpose for which the outer component completely surrounds the inner component is because the inner component viscosity is very low during the manufacturing process and if the outer component does not surround the low viscosity inner component at all times, it will readily leak out of any openings in the outer component resulting in both the loss of the inner component and a messy manufacturing process. In the case of the high fat, low water activity inner component described in the '746 patent the inner component may increase in viscosity after the manufacturing process because fats contained in the filling may crystallize, however, these fillings will have very low viscosity during manufacturing probably due to being handled at elevated temperatures and will therefore not be suitable for open-ended dual-texture products.

The prior art also contains disclosures related to products designed to assist in delivering medicants to animals. Medicants in the form of pills or capsules are often difficult to administer to companion animals such as dogs and cats because of the bad taste and poor palatability of these medicants. One way of improving this delivery process is to hide the medicant pill or capsule in a highly palatable material. One such example of a product providing for this means of medicant delivery is the Pill Pockets® product described on the internet at http://www.greenies.com/en_us/Products/DogPillPockets.aspx, incorporated herein by reference. These products have a soft and malleable texture and are designed with a hollow cavity into which a pill or capsule medicant can be inserted and then the material molded around the medicant, completely enclosing it in the soft, malleable, highly palatable material. Once the medicant is so hidden in the highly palatable material, it is more readily ingested by the animal.

Another example of a medicant delivery system is disclosed in U.S. Pat. No. 4,857,333 to Harold, incorporated herein by reference, which discloses a chewable pet treat having pre-formed pocket opening onto an outer surface into which a pill or capsule can be placed and the pill or capsule can be held in place by several means including deforming material around the medicant, or the pocket having tapered sides and thereby holding the medicant in the pre-formed pocket by a wedging action.

Another example of a medicant delivery system is disclosed in U.S. Pat. No. 6,143,316 to Hayden et. al., incorporated herein by reference, which describes, among other methods, a medicant delivery method whereby a medicant form is inserted into a pre-formed pocket, and then the pocket is subsequently filled with a plug of palatable food stuff to both hide the medicant and to keep it contained within the pocket while it is administered and ingested without a struggle between the pet and the individual administering the medicant.

Another example of a medicant delivery system is disclosed in US Patent Application Publication US2005/0255148 by Puma, incorporated herein by reference, which describes, a treat for administering medication to a pet or animal that is baked, has a pouch with an interior adhesive bed. This product is baked and not co-extruded and the methods of manufacturing described are complex and capital and/or labor intensive. The considerable advantage of the present invention is that manufacturing by co-extrusion processing is much more efficient and cost effective.

### SUMMARY OF THE INVENTION

The present disclosure provides a greatly improved co-extruded dual texture pet treat comprised of an outer harder shell portion and an inner softer filling portion. In the case of the present invention, the outer harder shell portion does not completely surround the inner softer filling portion. In the preferred form, the outer harder shell portion appears to have a generally tubular shape which surrounds the inner softer filling portion on all sides except the ends of the generally tubular shape. As such, the present invention is termed an open-ended product meaning that the inner softer filling portion is exposed on the ends of the tubular shaped outer harder shell material. The cross-section of the tube in this case may be any geometric shape including circular, triangular, square, or any other shape that may be envisioned by those skilled in the art.

In contrast to the prior art, the present invention provides for a pet treat where the texture differential between the outer harder shell portion and the inner softer filling portion is much larger than heretofore realized in open-ended pet treat products. This is accomplished by the use of a very soft, yet sufficiently viscous, inner softer filling material combined with an outer harder shell material of typical hardness in the art. The inner softer filling material used in the present invention has a viscosity that is low enough to facilitate manufacturing of the invention by co-extrusion means, yet high enough that it does not exit from the open ends of the product after the tubular portion of the co-extruded dual texture product is cut to length, such as during further processing steps such as conveying, drying, cooling, and packaging or during product storage in the package.

The product described herein is co-extruded meaning that the outer harder shell material is continuously manufactured by a cooking or forming extruder and the inner softer filling material is continuously combined with the shell materials by means of a co-extrusion die. The co-extrusion die combines the flows of each material resulting in a continuous flow stream of the combined outer and inner materials.

Another highly beneficial aspect of the present invention attributable to the open ends of the co-extruded dual texture product and the inner softer filling material is that it can be used by pet owners to assist in delivering medicants in the form of tablets or pills to their pets. The open ends and pre-installed inner softer filling allows a medicant to be inserted through one of the open ends such that it is positioned generally inside the outer harder shell portion. The inner softer filling is then sufficiently sticky or tacky to stick to the medicant and hold it in position generally inside the outer harder shell portion so that it is hidden from the pet. The pet will readily eat the treat and ingest the medicant without sensing that the medicant is present and rejecting it. The individual administering the medicant to the pet is not required to add any material to hold the medicant in place or to substantially deform the product to enclose the medicant.

### BRIEF DESCRIPTION OF THE DRAWINGS

FIG. 1 is diagram illustrating the disclosed invention—a co-extruded dual texture, open ended product in several optional cross-sectional shapes

FIG. 2 is a diagram illustrating the disclosed invention in a form suitable for insertion of a medicant into the softer inner portion and the inserted medicant held in position by the softer inner portion.

FIG. 3 is a diagram illustrating a process for manufacturing the disclosed invention.

### DETAILED DESCRIPTION

As required, detailed embodiments of the co-extruded dual-texture product invention are disclosed herein; however, it is to be understood that the disclosed embodiments are merely exemplary of the co-extruded dual texture products and the process for manufacturing the same, which may be embodied in various forms. Therefore, specific structural and functional details disclosed herein are not to be interpreted as limiting, but merely as a basis for the claims and as a representative basis for teaching one skilled in the art to variously practice the invention in virtually any appropriately detailed structure.

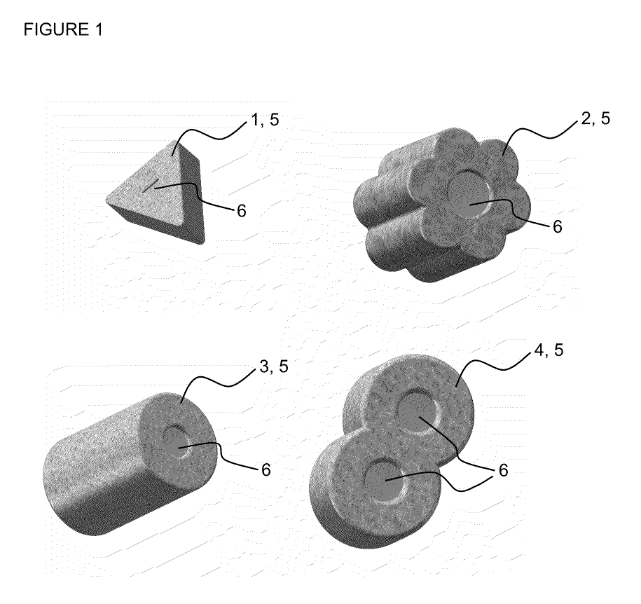

Referring now to the drawing figures, FIG. 1 illustrates several preferred embodiments of the present invention having several different cross-sectional shapes including a triangle cross section 1, a flower shape cross section 2, a circular cross section with a length dimension longer than a diameter dimension 3, and a dual-core cross section 4. Each of these example shapes have an outer harder shell portion 5 and an inner softer filling portion 6 where the inner softer filling portion 6 is exposed on both ends and is thus not completely surrounded by the outer harder shell portion 5. The shapes disclosed in FIG. 1 are not intended to be limiting, but rather to show several preferred embodiments of the present invention in terms of cross-sectional shape and length to cross-section dimensional ratio.

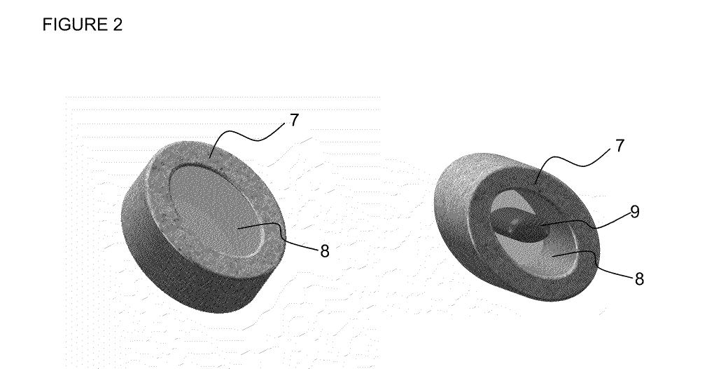

FIG. 2 illustrates a preferred embodiment of the present invention which has an outer harder shell portion 7 and a inner softer filling portion 8 which is suitable for insertion of a medicant 9 such as a caplet which is illustrated in FIG. 2. FIG. 2 illustrates that the medicant 9 is completely surrounded by the inner softer filling portion 8 and that the inner softer filling portion 8 holds the medicant 9 in position within the treat. However, it should be noted that it is not a requirement of the present invention that the inner softer filling portion 8 completely surround the medicant 9 and that depending on the size of the dual texture product and the size of the medicant 9, some embodiments of the present invention may result in the medicant 9 extending past the ends of the outer harder shell portion 7.

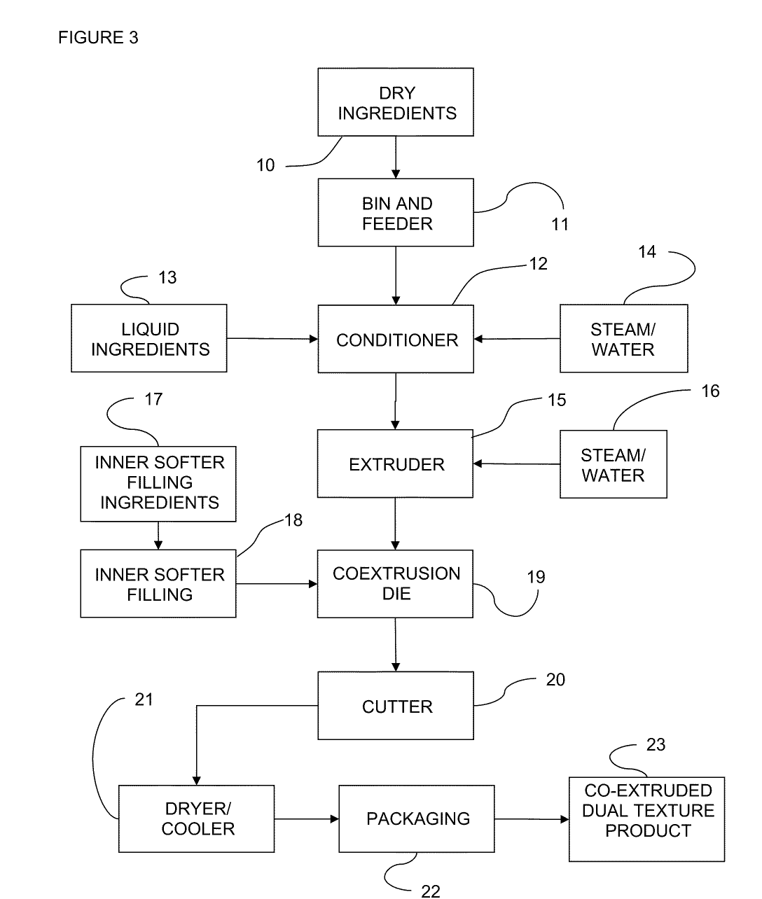

FIG. 3 illustrates in a block-diagram for a process that can be used to manufacture a co-extruded dual texture product. The outer harder shell portion of the co-extruded dual texture product is made by combining dry ingredients 10 typically used for manufacturing extruded products. These ingredients include, but are not limited to, cereal grains (such as wheat, rice, maize, barley, oats, rye, grain sorghum, and derivatives and isolates from these sources), plant proteins (from sources such as soybeans, peas, etc.), dry sources of animal proteins (such as poultry meal, chicken meal, meat and bone meal, etc.) vitamins and minerals, pH modifiers (citric acid, sorbic acid, etc.), mold inhibitors (potassium sorbate, calcium sorbate, etc.), antioxidants, and processing aids. The dry ingredients 10 are combined and milled in order to reduce particle size to a range suitable for extrusion as is well understood in the art.

The dry ingredients 10 are delivered to a bin and feeder system 11 which is used to meter them into the conditioner 12 or possibly directly into the extruder 15. Liquid ingredients 13 and steam and water 14, may be added into the conditioner for continuous blending with the dry ingredients 10 and for moistening and partial cooking. Liquid ingredients 13 added during this step of the process may include fresh sources of animal proteins (such as fresh poultry, beef, pork, venison, etc.), fats and oils (such as tallow, poultry fat, corn oil, soybean oil, sunflower oil, etc.) meat digests (included to enhance palatability of animal foods), and liquid pH modifiers (such as phosphoric acid, hydrochloric acid, etc.).

From the conditioner 12 conditioned materials fall into the cooking extruder 15 which may be either a single screw or twin screw extruder as may be preferred by practitioners of the art and may include either single stage or dual stage extrusion and may be configured for either forming or cooking functions or both. Liquid ingredients 13 as well as additional steam and water 16 may be optionally added to the extruder 15 to assist in controlling the process and the amount of cooking accomplished in the extruder 15. In the extruder 15, various process variables (such as screw speed, barrel temperature, etc.) are controlled as is well understood by practitioners of the art to deliver a stream of cooked or partially cooked dough to the co-extrusion die 19 which caps the end of the extruder 15.

The inner softer filling portion 18 of the present invention is prepared by combining softer inner filling ingredients 17 including, but not limited to, corn syrup, water, dextrose, sugar, oil, fat, salt, sorbic acid, phosphoric acid, emulsifiers, colors, artificial or natural flavors, meat digest, glycerin, starch, modified starches, pectin, gums, and the like. The inner softer filling ingredients are combined in a jacketed kettle as is typical in the art and well mixed at room temperature. After mixing, heat is applied to the jacket to heat the materials to a pre-determined temperature, usually greater than 60° C. to activate the starch, pectin, and gum binders resulting in the mixture turning at least partially translucent and resulting in an increase in the viscosity of the mixture. When properly carried out under this invention, when the resulting mixture is cooled back to room temperature, the viscosity of the inner softer filling material 18 will increase, but still be low enough to be pumped using a progressive cavity or similar type of pump. It must certainly not be a solid or have a crystalline structure that makes the filling difficult to pump nor should it be a liquid that will readily flow under natural gravitational forces. The viscosity of the inner softer filling portion 18 at room temperature should be greater than about 1,000,000 cP and less than about 10,000,000 cP, and preferably greater than about 4,000,000 cP and less than about 8,000,000 cP.

The co-extrusion die 19 is designed to receive the extrudate of the formulation described above from the extruder 15 and cause it to flow around a central tube through which the inner softer filling portion 18 of the formulation described above is pumped as is well understood by practitioners of the art. The co-extrusion die 19 is designed to impart both an inner and outer shape to the stream of extrudate and this shape can be any number of cross-sectional shapes such as round, triangular, square, flower, or any number of other shapes as is well understood in the art and illustrated in FIG. 1. The resulting extrudate stream which exits the co-extrusion die 19 can be viewed as a tube with a cross section as imparted by the co-extrusion die 19 with the central part of the tube being either partially or fully filled with the softer inner filling portion.

The filled extrudate tube may be cut to length as it exits the co-extrusion die 19 by a cutter 20. The cutter 20 is typically a rotating knife that has one or more cutting blades attached and mounted in very close proximity to the exit of the co-extrusion die 19, or is a servo or fly type cutting device where the filled tube is transferred downstream on a conveyor to the cutter 20. The down stream servo or fly type cutter is typically used for shapes that are larger in cross section or longer in length while the rotating knife cutter mounted in close proximity to the co-extrusion die exit is used for shapes that are smaller in cross section and shorter in length. In practicing the present invention, the result of the cutting operation will be an open ended product as is illustrated in FIG. 1.

After cutting the product to length by the cutter 20, the product, which is the outer harder shell portion containing the inner softer filling portion, may be transferred to a dryer/cooler system 21 where warm air is circulated over and around the dual-texture product to reduce its moisture content. At the point where the product enters the dryer/cooler 21, the moisture content of the outer harder shell portion is about 6% to 30% and the inner softer filling portion is about 20% to 40%. The air temperature employed in the dryer and the time that product is held in the dryer can be generally determined by those skilled in the art, and is approximately in the range of 65° C. to 150° C. and for a time in the range of 10 to 60 minutes. This drying part of the process is differentiated from baking by the relatively lower air temperatures utilized compared to the baking process. As the product exits the dryer it may be optionally cooled by circulating ambient or cooled air over the product in the fashion that is well understood by practitioners of the art.

In the dryer/cooler 21, moisture will be preferentially removed from the outer harder shell portion because it is generally more porous and/or is more exposed to the drying air than the inner softer filling portion. Some moisture however will also be removed from the inner softer filling portion. The overall product may also be elevated in temperature by the warm circulating air, but in most cases will not exceed about 65° C. Thus the viscosity of the inner softer filling portion during this process of heating and moisture reduction in the dryer should not be reduced sufficiently to cause the inner softer filling portion to leak out of the product. The viscosity of the inner softer filling portion under these conditions must be greater than about 1,500,000 cP and preferably greater than about 2,500,000 cP. After the drying process, the outer harder shell portion will generally be lower moisture (about 4% to 12%) than the inner softer filling portion (about 20% to about 35%). In addition, water activity of the harder outer shell portion will be lower (about 0.6 to about 0.8) than the water activity of the inner softer filling portion (about 0.7 to about 0.9)

After cooling the co-extruded dual-texture product 23 will be packaged 22 in a manner generally used in the art of manufacturing foods and pet foods. After cooling, moisture will tend to migrate from the inner softer filling portion of the co-extruded dual texture product 23 to the outer harder shell portion. This equilibration process may take up to about several weeks. After equilibration, the outer harder shell portion of the co-extruded dual texture product 23 will have moisture content in the range of about 8% to 13% and the softer inner filling portion will have moisture content in the range of about 15% to 30%. Water activity of both portions will be approximately equal at equilibration with a value of about 0.65 to about 0.75.

After equilibration, a unique aspect of the present invention is that the outer harder shell portion is much harder than the softer inner filling portion. The outer harder shell portion and inner softer filling portion hardness may be determined by using an instrument such as a Texture Analyzer to insert a conical-ended ⅛ inch diameter rod into the respective portions of the product at a prescribed velocity of 0.3 mm/sec. The hardness of the respective components can be related to the maximum force encountered during the process of inserting the rod through each portion. By this, or a similar, method the hardness of the harder outer shell portion is at least about 75 times greater than the hardness of the softer inner filling portion, preferably at least about 95 times greater, resulting an vastly improved dual-texture product with open ends with a large textural differential between the outer and inner components.

The inner softer filling portion 18 is pumped into the co-extrusion die 19 at room temperature or possibly at elevated temperature, but elevated temperature is not required to make the inner softer filling material pumpable and is generally not preferred. As the inner softer filling portion 18 is pumped and flows into the harder outer shell portion which is supplied by the extruder 15 through the co-extrusion die 19, the inner softer filling portion 18 may warm somewhat. The harder outer shell portion material may be warm (approximately 50-95° C.) after it exits the co-extrusion die 19 and the inner softer filling portion will thus be warmed. In addition, after cutting the product to length and the product is passed into the dryer, it will be warmed further. In addition, after packaging, the product could be stored in the package in a hot, warehouse where it may again be warmed. A key feature of the present invention is that at all of these locations during manufacturing and up to the point of reaching the consumer, the viscosity of the softer inner filling portion is not reduced to a point that it will leak out of the open ends of the co-extruded dual texture pet treat product and result in a mess either during manufacturing (cutting, drying, and packaging), in the package, or when removed from the package by the consumer. In order to accomplish this unique aspect of the present invention, the viscosity of the inner softer filling portion should at no time after the manufacture of the inner softer filling portion be less than about 1,500,000 cP and preferably not less than about 3,000,000 cP.

The preferred embodiment of the present co-extruded dual texture product invention is further expressed by the following examples.

### EXAMPLE 1

A co-extruded dual texture food product suitable for use in administering medicants to dogs was prepared using the following procedure. An inner softer filling material was prepared approximately 18 hours prior to the co-extrusion operation, described below. The inner softer filling material was prepared by combining the following ingredients in the amounts indicated and in the order listed under the conditions of continuous mixing in a steam-jacketed vessel. Combining the ingredients is done without the application of steam to the jacket.
50% Corn syrup
25% Water
15% Binder premix containing modified starch, rice flour, emulsifier, salt, fiber, milk powder, pectin and carrageenan gum
5.53% Dextrose
3% Palm Oil
0.68% Salt
0.3% Flavor
0.28% Sorbic acid
0.2% Emulsifier
0.02% Color

Mixing of the ingredients listed above resulted in a relatively thick paste with an opaque and grainy appearance. This paste was then heated, under continuous stirring to about 85° C. at which point the binder ingredients (rice flour, modified starch, pectin and carrageenan gum) in the binder blend solubilize and thicken and the paste appears more translucent and non grainy. This inner softer filling material was allowed to cool and was used approximately 18 hours later for co-extrusion as described below.

The viscosity of this inner softer filling material was measured using a Model RVDVII+ viscometer and a LV4 spindle both from Brookfield Engineering Laboratories, Inc., Middleboro, Mass. Viscosity was measured at 0.5 rpm spindle speed with the inner softer filling material adjusted to various temperatures. At each temperature, viscosity and temperature was measured and at least eight temperature and viscosity readings recorded over the course of 10 minutes. The temperature and viscosity readings were averaged for each temperature test with the following results.

| Temperature | Viscosity |
|---|---|
| (° C.) | centi-Poise (cP) |
| 14.9 | 9,943,429 |
| 33.3 | 7,721,714 |
| 41.0 | 6,101,571 |
| 54.0 | 4,744,857 |
| 79.1 | 311,771 |

The viscosity of this inner softer filling material was also measured using the same viscometer and spindle setup as described above, but at 1.0 rpm spindle speed with the following results.

| Temperature | Viscosity |
|---|---|
| (° C.) | centi-Poise (cP) |
| 15.1 | 5,807,714 |
| 35.4 | 4,990,286 |
| 46.3 | 3,070,714 |
| 60.3 | 2,439,857 |

Dry ingredients for manufacturing the outer harder shell of the product were procured in the ratios set forth below and were mixed and ground to an appropriate particle size for the extrusion cooking process.
77.6% Rice Flour
10% Dextrose
5% Oat Fiber
3% Poultry Fat
0.75% Emulsifier
0.28% Sorbic Acid
0.25% Citric Acid
0.05% Antioxidant
0.03% Color

The mixed and ground dry ingredients were metered into the extrusion system using a dry ingredient feeder at 153 kg/hr. The extrusion system used was a Clextral BC-72 twin screw extruder (Clextral, Inc., Tampa, Fla.). In the extruder, 12.3 kg/hr water and 1.1 kg/hr of poultry fat were added. The extruder was operating at 200 rpm screw speed resulting in a motor current draw of 21 amps while further mixing, cooking, and pumping the mixture. The discharge end of the extruder was capped by a co-extrusion die with 1 final opening which included an opening for forming and shaping the outer harder shell of the product and a tube through which the filling described above was pumped. A pressure of 96.5 bar to 103.4 bar was created just prior to the final die. The outer opening shape was round opening at 19.1 mm diameter. The inner tube shape was round in cross section with a diameter of 12.7 mm. Filling was pumped using a progressive cavity pump through the inner filling tube of the co-extrusion die at 13.6 kg/hr resulting in a tube that was from about 65% to about 100% filled with filling. The resulting tube outer dimensions were about 25.4 mm and inner dimensions were about 15.2 mm.

The tube of product was transferred on a conveyor belt to a servo cutting device supplied by ESI, Akron, Ohio. The cutting device was set to pull the product at 80 feet per minute and cut the product to 25.4 mm in length. Cutting was accomplished without leakage of filling from the shell.

After cutting the moisture content of the outer shell was 11.4%. The water activity of the inner filling was 0.846.

The cut pieces of the dual-texture pet treat were conveyed to a continuous two-pass drying system where they were conveyed through circulated air with a temperature of 116° C. for 32 minutes. After drying, the pieces were directly conveyed into a cooler where ambient air was circulated past the product for 10 minutes.

After exiting the cooling system, the moisture content of the outer shell was about 6.8% and the moisture content of the inner filling was 29.4%. The water activity of the outer shell was 0.628 and the water activity of the inner filling was 0.797.

The pieces were packaged in sealed containers and held for 15 days time to allow the pieces to equilibrate. After equilibration, the moisture content of the outer shell was 12.4% and the moisture content of the inner filling was 18.9%. The water activity of the outer shell was 0.699 and the water activity of the inner filling was 0.716.

About 20 weeks after production, the texture of pieces of this product was measured using a TATX2 Texture Analyzer equipped with a ⅛ inch diameter probe with a conical end. The texture of the inner softer portion of the product was tested by placing the product on end with an open end of the product facing upward. The probe was advanced into the inner soft portion at a velocity of 0.3 mm/sec to point equal to 99% strain. Maximum force in grams force was determined from the force versus distance curve. Ten pieces were measured with the results of 62.4, 77.5, 66.8, 78.2, 74.3, 59.6, 69.2, 69.0, 57.4, and 64.0. Average maximum force was calculated to be 67.8 grams.

The texture of the outer harder portion of the product was tested by removing approximately ½ of the outer hard portion and placing the product with the harder outer portion on the instrument table and the remaining softer inner portion facing upward. The probe was advanced through the inner soft portion into the harder outer portion at a velocity of 0.3 mm/sec to point equal to 99% strain. Maximum force in grams force was determined from the force versus distance curve. Ten pieces were measured with the results of 5814, 7636, 7582, 9470, 6367, 6513, 7055, 7470, and 5400. Average maximum force was calculated to be 6986 grams. From this data the texture differential between the harder outer portion and the softer inner portion was calculated to be 103.

### EXAMPLE 2

A co-extruded dual texture food product suitable for use as a highly palatable cat food product was prepared using the following procedure. A soft, inner filling was prepared approximately 18 hours prior to the co-extrusion operation, described below. The filling was prepared by combining the following ingredients in the amounts indicated and in the order indicated under the conditions of continuous mixing in a steam-jacketed vessel. Combining the ingredients is done without the application of steam to the jacket.
43% Corn syrup
24% Water
15% Binder premix containing modified starch, rice flour, emulsifier, salt, fiber, milk powder, pectin and carrageenan gum
6% Glycerin
5.28% Dextrose
3% Palm Oil
2.5% Meat digest
0.68% Salt
0.25% Sorbic acid
0.25% emulsifier
0.05% Color

Mixing of the ingredients listed above resulted in a relatively thick paste with a relatively opaque and grainy appearance. This paste was then heated, under continuous stirring to about 85° C. at which point the binder ingredients in the binder blend solubilize and thicken and the paste appears more translucent and non grainy. This paste was allowed to cool and was used approximately 18 hours later for co-extrusion as described below.

Dry ingredients for manufacturing the harder outer shell of the treat were procured in the ratios set forth below and were mixed and ground to an appropriate particle size for the extrusion cooking process.
38% Chicken meal
25% Corn
12% Corn gluten meal
11.8% Wheat
4% Poultry fat
3% Oat fiber
2% Meat digest
1% Brewers yeast
0.6% Calcium carbonate
0.6% Potassium choride
0.3% Salt
0.3% Choline choride
0.25% Sorbic Acid
0.25% Lecithin
0.25% Citric Acid
0.2% Vitamin premix
0.1% Color
0.1% Mineral premix
0.1% Methionine
0.08% Taurine
0.02% Antioxidant

The mixed and ground dry ingredients were metered into the extrusion system using a dry ingredient feeder at 871 kg/hr. The extrusion system used included a 10×72 preconditioner from Extru-Tech, Inc., Sabetha, Kans., followed by a Clextral BC-72 twin screw extruder (Clextral, Inc., Tampa, Fla.). In the preconditioner, 128 kg/hr of water along with sufficient steam to result in a partially cooked material entering the extruder at 106° C. were added. In the extruder, 41.4 kg/hr of poultry fat was added. The extruder was operating at 200 rpm screw speed resulting in a motor current draw of 27 amps while further mixing, cooking, and pumping the mixture. The discharge end of the extruder was capped by a co-extrusion die with 6 final openings which included an opening for forming and shaping the outer harder shell of the product and a tube through which the filling described above was pumped. The moisture content of the filling was 25.5% and the water activity of the filling was 0.765. The outer opening shape was an equilateral triangle with slightly concave sides and rounded points having a height of 11.7 mm. The inner tube shape was round in cross-section with a diameter of 9.5 mm. Filling was pumped using a progressive cavity pump through the inner filling tubes of the co-extrusion die at 164 kg/hr. As the product exited the co-extrusion die, it was cut to length at the die face by a rotating knife with two knife blades rotated at 675 rpm. The resulting product outer dimensions were about 17.8 mm (base to point) and inner dimensions were about 3 mm and length 7.1 mm. Cutting was accomplished without leakage of filling from the shell.

The cut pieces of the dual-texture pet treat were conveyed to a continuous two-pass drying system where they were conveyed through circulated air with a temperature of 127° C. for 32 minutes. After drying, the pieces fell directly into a cooler where ambient air was circulated past the product for 10 minutes. There was no leakage of the filling from the shell during the drying and cooling process.

After exiting the cooling system, the moisture content of the outer shell was 6% to 11% and the moisture content of the entire product was 7.2% to 13.4%. The water activity of the outer shell was 0.447 to 0.755 and the water activity of the entire product was 0.508 to 0.757.

The pieces were packaged in sealed containers and held for some time to allow the pieces to equilibrate. There was no leakage of filling from the shell even after being in storage and the product did not become stuck together.

It is to be understood that while certain forms of the dual texture pet treat invention have been illustrated and described herein, it is not to be limited to the specific forms or arrangements described and shown.

I claim:

1. A co-extruded dual texture animal or human food product comprising a outer harder shell component and a inner softer filling component
where said outer harder shell component does not completely surround said inner softer filling component such that said inner softer filling component is exposed in at least two locations
where said inner softer filling component has a viscosity at room temperature that is low enough to pump into a co-extrusion die during co-extrusion of said co-extruded dual texture product
where said inner softer filling component has a viscosity that is high enough to not run out of the open ends of said harder outer shell component during cutting, drying, packaging, and storage of said co-extruded dual texture product
where hardness of said outer harder shell component is greater than about 75 times the hardness of said inner softer filling component after said outer harder shell component and said inner softer filling component are allowed to equilibrate with one another
where said inner softer filling component has a hardness such that less than about 0.5 kg force is required to insert a ⅛″ diameter steel pin at 2 cm/min velocity into said inner softer filling component after said outer harder shell component and said inner softer filling component are allowed to equilibrate with one another

2. The co-extruded dual texture product of claim 1 where said viscosity of said inner softer filling component is from about 1,000,000 cP to about 10,000,000 cP at room temperature.

3. The co-extruded dual texture product of claim 2 where said viscosity of said inner softer filling component is from about 4,000,000 cP to about 8,000,000 cP at room temperature.

4. The co-extruded dual texture product of claim 1 where said viscosity of said inner softer filling component is at least about 1,500,000 cP when measured at 65° C.

5. The co-extruded dual texture product of claim 4 where said viscosity of said inner softer filling component is at least about 2,500,000 cP when measured at 65° C.

6. The co-extruded dual texture product of claim 1 where said outer harder shell component is greater than about 95 times harder than said inner softer filling component after said outer harder shell component and said inner softer filling component are allowed to equilibrate with one another.

7. The co-extruded dual texture product of claim 1 where said inner softer filling component has a hardness such that less than about 0.2 kg force is required to insert a ⅛″ diameter steel pin at 2 cm/min velocity into said inner softer filling component after said outer harder shell component and said inner softer filling component are allowed to equilibrate with one another.

8. The co-extruded dual texture product of claim 7 where said inner softer filling component has a hardness such that less than about 0.1 kg force is required to insert a ⅛″ diameter steel pin at 2 cm/min velocity into said inner softer filling component after said outer harder shell component and said inner softer filling component are allowed to equilibrate with one another.

9. A co-extruded dual texture animal or human food product comprising a outer harder shell component and a inner softer filling component
where said outer harder shell component does not completely surround said inner softer filling component such that said inner softer filling component is exposed in at least two locations
where said inner softer filling component has a viscosity at room temperature that is low enough to pump into a co-extrusion die during co-extrusion of said co-extruded dual texture product
where said inner softer filling component has a viscosity that is high enough to not run out of the open ends of said harder outer shell component during cutting, drying, packaging, and storage of said co-extruded dual texture product
where hardness of said outer harder shell component is greater than about 75 times the hardness of said inner softer filling component after said outer harder shell component and said inner softer filling component are allowed to equilibrate with one another
where said inner softer filling component has a hardness such that less than about 0.5 kg force is required to insert a ⅛″ diameter steel pin at 2 cm/min velocity into said inner softer filling component after said outer harder shell component and said inner softer filling component are allowed to equilibrate with one another
where said inner softer filling component is arranged to receive a medicant such that said medicant is held in place by said inner softer filling component to facilitate ingestion of said medicant by an animal

10. The co-extruded dual texture product of claim 9 where said viscosity of said inner softer filling component is from about 1,000,000 cP to about 10,000,000 cP at room temperature.

11. The co-extruded dual texture product of claim 10 where said viscosity of said inner softer filling component is from about 4,000,000 cP to about 8,000,000 cP at room temperature.

12. The co-extruded dual texture product of claim 9 where said viscosity of said inner softer filling component is at least about 1,500,000 cP when measured at 65° C.

13. The co-extruded dual texture product of claim 12 where said viscosity of said inner softer filling component is at least about 2,500,000 cP when measured at 65° C.

14. The co-extruded dual texture product of claim 9 where said outer harder shell component is greater than about 95 times harder than said inner softer filling component after said outer harder shell component and said inner softer filling component are allowed to equilibrate with one another.

15. The co-extruded dual texture product of claim 9 where said inner softer filling component has a hardness such that less than about 0.2 kg force is required to insert a ⅛″ diameter steel pin at 2 cm/min velocity into said inner softer filling component after said outer harder shell component and said inner softer filling component are allowed to equilibrate with one another.

16. The co-extruded dual texture product of claim 15 where said inner softer filling component has a hardness such that less than about 0.1 kg force is required to insert a ⅛″ diameter steel pin at 2 cm/min velocity into said inner softer filling component after said outer harder shell component and said inner softer filling component are allowed to equilibrate with one another.
